(19) United States
(12) Patent Application Publication
(10) Pub. No.: US 2006/0274132 A1
(43) Pub. Date: Dec. 7, 2006

(54) Bonding structure and method of bonding an array head of an ink cartridge

(76) Inventor: Jong-suk Seo, Suwon-si (KR)

Correspondence Address: STANZIONE & KIM, LLP, 919 18TH STREET, N.W., SUITE 440, WASHINGTON, DC, 20006, US

(21) Appl. No.: 11/429,984

(22) Filed: May 9, 2006

(30) Foreign Application Priority Data
Jun. 1, 2005 (KR) 2005-46735

(51) Int. Cl. B41J 2/175

(52) U.S. Cl. 347/87

(57) ABSTRACT

A bonding structure to align and bond a plurality of print heads on an ink channel unit of an ink cartridge includes a preliminary bonding tab, a main adhesive, a plurality of print heads, and a preliminary adhesive. At least one preliminary bonding tab is formed at a perimeter of each of a plurality of print head bonding areas on a surface of an ink channel unit. A main adhesive is applied to each of the plurality of print head bonding areas. The plurality of print heads are arranged respectively over the main adhesive. A preliminary adhesive is applied to spaces between each of the plurality of print heads and at least one preliminary bonding tab corresponding thereto. When a plurality of print heads are preliminarily bonded by the preliminary adhesive, the plurality of print heads are bonded to the surface of the ink channel unit by heating and hardening a main adhesive.

### CROSS-REFERENCE TO RELATED APPLICATIONS

This application claims priority under 35 U.S.C. §119(a) from Korean Patent Application No. 2005-46735, filed on Jun. 1, 2005, in the Korean Intellectual Property Office, the disclosure of which is incorporated herein in its entirety by reference.

### BACKGROUND OF THE INVENTION

1. Field of the Invention

The present general inventive concept relates to a multi array head-type ink cartridge, and more particularly, to a bonding structure and method of bonding an array head of an ink cartridge that aligns and bonds a plurality of print heads to an ink channel unit having ink channels.

2. Description of the Related Art

Inkjet printers are machines that discharge minute droplets of printing ink on a surface of paper, fabric, or other print medium at specified locations in order to print a specific-colored image on the medium.

Conventional inkjet printers have ink cartridges that move back and forth across a print medium (paper, for example) in a direction perpendicular to a feed direction of the medium (i.e., a width of the medium) in order to print an image thereon. Such conventional inkjet printers employing an ink cartridge moving back and forth across the medium to print an image, however, have a drawback of a slow printing speed.

Recently, inkjet printers have been developed that use ink cartridges with multiple print heads covering an entire width of a print medium so that the ink cartridge does not have to move back and forth across the medium, and an image can be printed at a faster speed. Such inkjet printers are called multi array head-type inkjet printers.

FIG. 1 is a plan view illustrating a conventional multi array head-type ink cartridge, and FIG. 2 is a perspective view illustrating a method of bonding a plurality of print heads 50 to an ink channel unit 40 of the conventional multi array head-type ink cartridge of FIG. 1.

Referring to FIGS. 1 and 2, the conventional multi array head-type ink cartridge includes: a plurality of ink tanks 21, 22, 23, and 24 holding printing ink, a plurality of pressure control portions 31, 32, 33, and 34 respectively connected to corresponding ones of the plurality of ink tanks 21, 22, 23, and 24, the plurality of print heads 50 arranged in a predetermined pattern along a width of a print medium, and the ink channel unit 40 to supply ink to the plurality of print heads 50 from the plurality of ink tanks 21, 22, 23, and 24.

The plurality of ink tanks 21, 22, 23, and 24 are installed on a frame 10, respectively holding inks of various colors, for example, yellow (Y), magenta (M), cyan (C), and black (K), as illustrated in FIG. 1.

The plurality of pressure control portions 31, 32, 33, and 34 are installed at a lower portion of the frame 10 and are connected to the corresponding ones of the plurality of ink tanks 21, 22, 23, and 24. The plurality of pressure control portions 31, 32, 33, and 34 generate negative pressure in order to prevent ink from leaking from the corresponding ones of the plurality of ink tanks 21, 22, 23, and 24.

The ink channel unit 40 is connected to the plurality of pressure control portions 31, 32, 33, and 34, and supplies each print head 50 with ink flowing from the plurality of ink tanks 21, 22, 23, and 24 through the pressure control portions 31, 32, 33, and 34. The ink channel unit 40 is formed of a plurality of channel plates 41, 42, and 43. For example, the ink channel unit 40, as illustrated in FIG. 1, is formed by stacking a first channel plate 41, a second channel plate 42, and a third channel plate 43 in sequence, and then bonding the plurality of channel plates 41-43 together. The first, second, and third channel plates 41, 42, and 43 have respective ink channels (not illustrated) for ink to flow through.

The plurality of print heads 50 are arranged in a predetermined pattern and bonded at the bottom of the ink channel unit 40 (that is, at the bottom of the first channel plate 41). Each print head 50 has a plurality of nozzles 52 formed thereon to eject ink therefrom. Ink supplied from the ink channel unit 40 is ejected through the plurality of nozzles 52 onto the print medium, thereby printing an image on the print medium.

A conventional bonding process to bond the plurality of print heads 50 at the bottom of the ink channel unit 40 will now be described with reference to FIG. 2.

First, an epoxy-base liquid adhesive 60 is applied to a surface area of the ink channel unit 40 to which the print head 50 is to be bonded. The adhesive 60 does not cover ink through holes 44 formed at the bottom of the ink channel unit 40, so that ink is ejected through the ink through holes 44. Next, the print head 50 is placed over the applied adhesive 60, and the assembly is heated at a predetermined temperature for a fixed period of time. Then, the adhesive 60 cures, bonding the print head 50 to the ink channel unit 40.

For multi array head-type inkjet cartridges, the plurality of print heads 50 must be precisely aligned with and bonded to the bottom surface of the ink channel unit 40. During the adhesive 60 curing process, however, the print head 50 placed over the adhesive 60 is prone to shift in position, which causes an alignment problem between the plurality of print heads 50. Also, after one print head 50 is properly aligned over a corresponding adhesive 60, the subsequent process of placing other print heads 50 on neighboring adhesives 60 can displace the first properly aligned print head 50.

To prevent the above problem, an ultraviolet (UV) adhesive 70 is conventionally applied to edge portions of the print head 50 to preliminarily bond the print head 50, after the print head 50 is placed on an adhesive 60, but before the adhesive 60 is heated.

However, in the above conventional method, the preliminary UV adhesive 70 mixes with the main (epoxy) adhesive, losing adhesiveness for the preliminary bonding of the print heads 50. In this instance, the previously described alignment problem between the plurality of print heads 50 emerges.

### SUMMARY OF THE INVENTION

The present general inventive concept provides a bonding structure, and method of bonding, an array head of an ink cartridge, and especially to a multi array head-type ink cartridge that prevents misalignment of a plurality of print heads that are bonded to an ink channel unit.

The present general inventive concept also provides a bonding structure, and method of bonding, a multi array head-type ink cartridge that prevents misalignment of a plurality of print heads that are bonded to an ink channel unit.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a bonding structure to align and bond a plurality of print heads on an ink channel unit of an ink cartridge, the structure including at least one preliminary bonding tab disposed around the perimeter of each of a plurality of print head bonding areas on the surface of the ink channel unit corresponding to the plurality of print heads, a main adhesive applied to each of the plurality of print head bonding areas, so that the plurality of print heads are arranged over the main adhesive at corresponding ones of the plurality of print head bonding areas, and a preliminary adhesive applied to spaces between each of the plurality of print heads and a corresponding one of the at least one preliminary bonding tab.

The at least one preliminary bonding tab may include a plurality of preliminary bonding tabs provided at the corresponding perimeter of each of the plurality of print head bonding areas. The at least one preliminary bonding tab may include a pair of preliminary bonding tabs diagonally disposed at opposite corners of each of the plurality of print head bonding areas. The at least one preliminary bonding tab may be spaced apart from the perimeter of a corresponding one of the plurality of print heads by a predetermined distance. The at least one preliminary bonding tab may have a height equal to or less than a height of the print head. The at least one preliminary bonding tab may have a shape of a square wall, a cylindrical wall, or a bent wall.

The ink channel unit and the at least one preliminary bonding tab may be formed of liquid crystal polymer. The main adhesive may be an epoxy-base adhesive. The preliminary adhesive may be an ultraviolet adhesive.

The foregoing and/or other aspects and utilities of the present general inventive concept may also be achieved by providing a bonding method to align and bond a plurality of print heads on an ink channel unit of of an ink cartridge, the method including forming at least one preliminary bonding tab at the perimeter of each of the plurality of print head bonding areas on the surface of the ink channel unit corresponding to the plurality of print heads, applying a main adhesive on each of the plurality of print head bonding areas so that the plurality of print heads are arranged over the main adhesive at corresponding ones of the plurality of print head bonding areas, and preliminarily bonding the plurality of print heads by applying a preliminary adhesive in the space between each print head and a corresponding one of the at least one corresponding preliminary bonding tab.

The at least one preliminary bonding tab may include a plurality of preliminary bonding tabs provided at the corresponding perimeter of each of the plurality of print head bonding areas at least one preliminary bonding tab may include a pair of preliminary bonding tabs diagonally disposed at opposite corners of each of the plurality of print head bonding areas. The at least one preliminary bonding tab may be spaced apart from the perimeter of the corresponding one of the plurality of print heads by a predetermined distance. The at least one preliminary bonding tab may have a height equal to or less than a height of the print head. The at least one preliminary bonding tab may have a shape of a square wall, a cylindrical wall, or a bent wall.

The at least one preliminary bonding tab may be injection molded in one piece with the ink channel unit. The ink channel unit and the preliminary bonding tab may be formed of liquid crystal polymer.

The main adhesive may be an epoxy-base adhesive. The preliminary adhesive may be an ultraviolet adhesive. The main and preliminary adhesives may be applied using a dispensing method.

The method may further include main-bonding the plurality of print heads to the surface of the ink channel unit by heating and hardening the main adhesive.

The foregoing and/or other aspects and utilities of the present general inventive concept may also be achieved by providing an ink cartridge, including an ink channel unit having a surface, and having an ink through hole and a bonding area formed on the surface, a print head disposed on the surface of the ink channel unit, and one or more bonding tabs formed on the surface of the ink channel unit to align the print head when the print head is attached to the bonding area.

The ink cartridge may further include a first bond disposed between the print head and the bonding area, and a second bond disposed between the print head and the one or more bonding tabs. The print head may include a first side facing the surface and a second side having an angle with the first side and the one or more bonding tabs may protrude from the surface of the ink channel unit along the second side of the print head. The one or more bonding tabs may be disposed along a side of the print head. The one or more bonding tabs may have a thickness corresponding to that of the print head. At least one of the first and second bonding tabs may be integral to the ink channel unit in a single monolithic body. At least one of the first and second bonding tabs may be attached to the ink channel unit after the ink channel unit is formed.

The foregoing and/or other aspects and utilities of the present general inventive concept may also be achieved by providing an ink cartridge, including an ink channel unit having a first surface with a first ink through hole and a first bonding area, and a second surface with a second ink through hole and a second bonding area, a first print head disposed on the first surface of the ink channel unit, a second print head disposed on the second surface of the ink channel unit, a first bonding tab formed on the first surface to guide the first print head with respect to the second print head and the ink channel unit, and a second bonding tab formed on the second surface to guide the second print head with respect to the first print head and the ink channel unit. The ink cartridge may further include a bonding material disposed between the first print head and the first bonding tab and between the second print head and the second bonding tab.

The foregoing and/or other aspects and utilities of the present general inventive concept may also be achieved by providing an image forming apparatus, including an ink channel unit having an ink channel, and having a surface with an ink through hole to communicate with the ink channel and a bonding area surrounding the ink through hole, a print head disposed on the surface of the ink channel unit, and having a nozzle to communicate with the ink through hole of the ink channel unit, one or more bonding tabs formed on the surface of the ink channel unit to align the print head when the print head is attached to the bonding area, and a bonding material disposed between a side of the print head and the one or more bonding tabs. The one or more bonding tabs can be disposed to restrict a movement of the print head in a direction parallel to the surface of the ink channel unit.

The foregoing and/or other aspects and utilities of the present general inventive concept may also be achieved by providing a method of making an ink cartridge, including forming an ink channel unit having a surface, and having an ink through hole and a bonding area formed on the surface, disposing a print head on the surface of the ink channel unit, and forming one or more bonding tabs formed on the surface of the ink channel unit to align the print head when the print head is attached to the bonding area.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a plan view illustrating a conventional multi array head-type ink cartridge;

FIG. 2 is a perspective view illustrating a conventional method of bonding multiple print heads of an ink channel unit;

FIG. 3 is a perspective view illustrating an array head bonding structure of an ink cartridge according to an embodiment of the present general inventive concept;

FIG. 4 is a side view illustrating the array head bonding structure of the ink cartridge in FIG. 3; and

FIGS. 5A and 5B are perspective views illustrating alternative embodiments of preliminary bonding tabs illustrated in FIGS. 3 and 4.

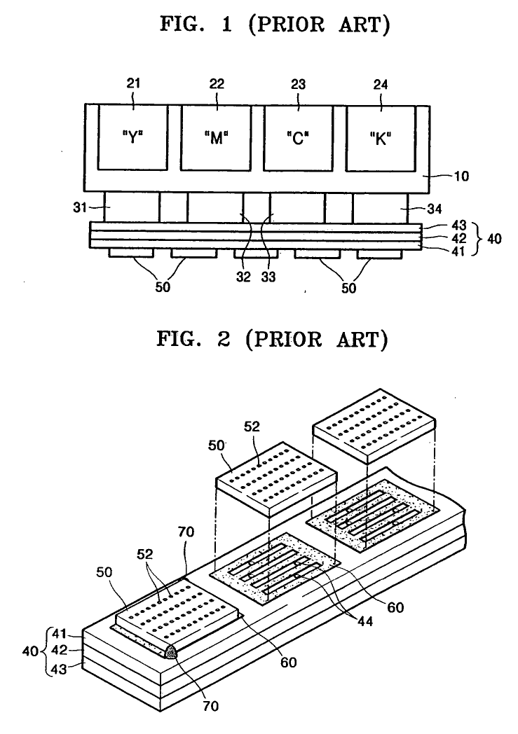

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

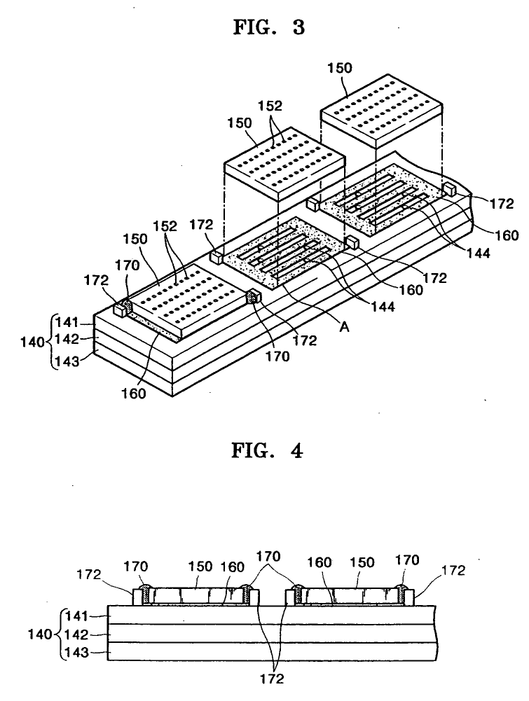

FIGS. 3 and 4 are a perspective view and a side view respectively illustrating an ink cartridge array head bonding structure useable with an image forming apparatus, such as a printer, according to an embodiment of the present general inventive concept.

Referring to FIGS. 3 and 4, inkjet printers discharge minute droplets of printing ink on a surface of paper, fabric, or other print medium at specified locations in order to print a specific-colored image on the print medium. Such inkjet printers can include an ink cartridge to store ink and can have a print head 150 through which the stored ink is discharged. Multi array head-type ink cartridges can have a plurality of print heads 150 arranged in a predetermined pattern along a width of a print medium, such as the paper. Furthermore, the ink multi array head-type ink cartridges can include an ink channel unit 140 to supply printing ink to the plurality of print heads 150 from a plurality of ink tanks (not illustrated) that store the ink.

The ink channel unit 140 can be formed by stacking a plurality of channel plates 141, 142, and 143 and bonding them together. For example, as illustrated in FIGS. 3 and 4, the ink channel unit 140 may be formed by sequentially stacking three channel plates, i.e., a first channel plate 141, a second channel plate 142, and a third channel plate 143. Alternately, the ink channel unit 140 may be formed with two, four, or more than four channel plates (as opposed to the three channel plates 141, 142, and 143 illustrated in FIGS. 3 and 4).

On each of the first, second, and third channel plates 141, 142, and 143, an ink channel (not illustrated) is formed for ink to flow through. For example, in order to supply ink to the plurality of print heads 150, a plurality of ink through holes 144 are formed through the first channel plate 141. The plurality of channel plates 141, 142, and 143 may be manufactured in many different ways. For example, each of the channel plates 141, 142, and 143 may be manufactured by injection molding using liquid crystal polymer (LCP). LCP is a favorable material because of its strength, high thermal endurance, and low thermal expansion coefficient. Thus, the possibility of the channel plates 141, 142, and 143 thermally expanding due to heat created during the print head's operation can be minimized by using LCP. Another benefit of LCP is that it is highly formable, so that minute ink channels can easily be formed therein. Additionally, LCP has low permeability, which prevents different colored inks passing through the ink channel from mixing.

In order to discharge ink, the plurality of print heads 150 each have a plurality of nozzles 152 formed on corresponding ones thereof. Ink supplied from the ink channel unit 140 is discharged through the nozzles 152 onto the print medium to print an image thereon.

The plurality of print heads 150 can be aligned in a predetermined pattern and bonded along a bottom of the ink channel unit 140, that is a bottom of the first channel plate 141. As illustrated in FIGS. 3 and 4, the plurality of print heads 150 can be bonded to the ink channel unit 140 in a preliminary bonding stage using a plurality of preliminary bonding tabs 172 and a preliminary bonding adhesive 70, and in a main bonding stage using a main adhesive 160.

The plurality of preliminary bonding tabs 172 used in the preliminary bonding stage can be formed to protrude from the bottom of the ink channel unit 140. At least one or two preliminary bonding tabs 172 (as illustrated in FIG. 3) may be formed for each print head 150. Alternately, three or more preliminary bonding tabs 172 may be formed for each print head 150. At least one preliminary bonding tab 172 is disposed on the perimeter around each print head bonding area (A). Two preliminary bonding tabs 172 may be disposed at two diagonally opposite corners of a print head bonding area (A). The preliminary bonding tabs 172 can be disposed a predetermined distance apart from a rim of the print head 150, so that the preliminary bonding adhesive 170 (which will be described later) can be applied to spaces formed between the print head 150 and the preliminary bonding tabs 172. The preliminary bonding tabs 172 may have heights equal to or lower than heights of the print heads 150 to prevent an aligning device to align the plurality of print heads 150 on the bottom surface of the ink channel unit 140 from contacting the preliminary bonding tab 172.

The preliminary bonding tabs 172 may be formed in one piece with the first channel plate 141 of the ink channel unit 140 when the first channel plate 141 is formed by injection molding. Alternatively, the preliminary bonding tabs 172 may be formed separately from the first channel plate 141 and attached to the bottom surface thereof after the first channel plate 141 id formed by injection molding. The preliminary bonding tabs 172 may be formed in a square wall shape, as illustrated in FIG. 3, or in any other suitable shape.

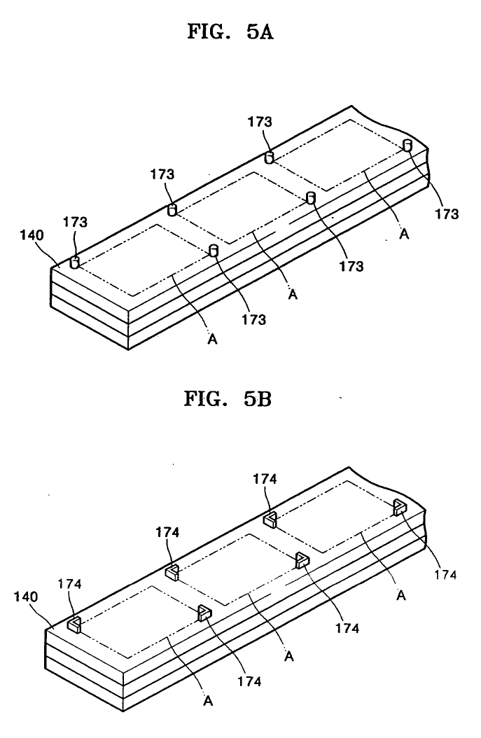

FIGS. 5A and 5B are perspective views illustrating alternative embodiments of the preliminary bonding tabs 172 in FIGS. 3 and 4. Referring to FIGS. 5A and 5B, preliminary bonding tabs 173 and 174 may be formed in a shape of, for example, a cylindrical wall or a bent L-shaped wall, instead of a square wall.

A bonding process to bond the plurality of print heads 150 to the bottom of the ink channel unit 140 will now be described with reference to FIGS. 3 and 4.

First, the ink channel unit 140, having the plurality of preliminary bonding tabs 172, is formed as previously described.

Next, the main adhesive 160 is applied on each of the print head bonding areas (A) at the bottom of the ink channel unit 140. Any suitable adhesive material may be used as the main adhesive 160, which should adhere well to the ink channel unit (such as the ink channel unit 140 made of LCP), and be non-reactive to the ink. For example, a liquid epoxy-base adhesive can be used as the main adhesive 160, such as when the ink channel 140 is made of LCR The main adhesive 160 may be applied using a dispensing method. Here, the main adhesive 160 can be applied so that it does not block the ink through holes 144 formed at the bottom of the ink channel unit 140. The main adhesive 160 may also be applied using a screen printing method.

Subsequently, a plurality of print heads 150 can be positioned over respective areas of the bottom of the ink channel unit 140 with the main adhesive 160 applied thereon.

Then, the preliminary adhesive 170 can be applied to the spaces between the plurality of print heads 150 and their corresponding preliminary bonding tabs 172, and then can be hardened. While many types of adhesive substances may be used as the preliminary adhesive 170, ultraviolet (UV) adhesive, which hardens quickly and easily when exposed to UV rays, may be used. The preliminary adhesive 170 may be applied using, for example, a dispensing method.

If the preliminary adhesive 170 is applied in the spaces between the print heads 150 and their corresponding preliminary bonding tabs 172, as explained above, the contact area of the preliminary and main adhesives 170 and 160 is minimized, preventing the possibility of the preliminary and main adhesives 170 and 160 from mixing. Also, due to the fact that the preliminary bonding tabs 172 maintain the preliminary adhesive 170 between the print heads 150 and the preliminary bonding tabs 172, preliminary bonds of the print heads 150 formed by the preliminary adhesive 170 are sufficiently robust.

Successively, the preliminarily bonded ink channel unit 140 and the plurality of print heads 150 are inserted into a heating oven and heated at a predetermined temperature. As a result, the main adhesive 160 applied between the ink channel unit 140 and the plurality of print heads 150 hardens to firmly bond the ink channel unit 140 to the plurality of print heads 150. Because the plurality of print heads 150 were firmly bonded to the preliminary bonding tabs 172 by the preliminary adhesive 170, misalignment problems during the heating and hardening of the main adhesive 160 do not occur.

As described above, by applying a preliminary adhesive between preliminary bonding tabs and a plurality of print heads to implement a preliminary bond, mixing of main and preliminary adhesives is minimized. In this manner, a sufficiently robust preliminary bond is obtained for the plurality of print heads, so that misalignment of the plurality of print heads during heating and hardening of the main adhesive is prevented.

Furthermore, after the plurality of print heads are preliminarily bonded, the main bonding of the plurality of print heads is conducted simultaneously, thereby reducing manufacturing time.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A bonding structure to align and bond a plurality of print heads on an ink channel unit of an ink cartridge, the structure comprising:
at least one preliminary bonding tab formed around a perimeter of each of a plurality of print head bonding areas on a surface of the ink channel unit corresponding to the plurality of print heads;
a main adhesive applied to each of the plurality of print head bonding areas, so that the plurality of print heads are arranged over the main adhesive at corresponding ones of the plurality of print head bonding areas; and
a preliminary adhesive applied to spaces between each of the plurality of print heads and a corresponding one of the at least one preliminary bonding tab.

2. The structure of claim 1, wherein the at east one preliminary bonding tab comprises a plurality of preliminary bonding tabs provided at the corresponding perimeter of the plurality of print head bonding areas.

3. The structure of claim 2, wherein the at least one preliminary bonding tab comprises a pair of preliminary bonding tabs diagonally disposed at opposite corners of the plurality of print head bonding areas.

4. The structure of claim 1, wherein the at least one preliminary bonding tab is spaced apart from a perimeter of a corresponding one of the plurality of print heads by a predetermined distance.

5. The structure of claim 1, wherein the at least one preliminary bonding tab has a height equal to or less than a height of the print head.

6. The structure of claim 1, wherein the at least one preliminary bonding tab has a shape of a square wall, a cylindrical wall, or a bent wall.

7. The structure of claim 1, wherein the ink channel unit and the at least one preliminary bonding tab are formed of liquid crystal polymer.

8. The structure of claim 1, wherein the main adhesive is an epoxy-base adhesive.

9. The structure of claim 1, wherein the preliminary adhesive is an ultraviolet adhesive.

10. A bonding method to align and bond a plurality of print heads on an ink channel unit of an ink cartridge, the method comprising:
forming at least one preliminary bonding tab at a perimeter of each of a plurality of print head bonding areas on a surface of the ink channel unit corresponding to the plurality of print heads;
applying a main adhesive on each of the plurality of print head bonding areas so that each of the plurality of print heads are arranged over the main adhesive at corresponding ones of the plurality of print head bonding areas; and
preliminarily bonding the plurality of print heads by applying a preliminary adhesive in a space between each of the plurality of print heads and a corresponding one of the at least one corresponding preliminary bonding tab.

11. The method of claim 10, wherein the at least one preliminary bonding tab comprises a plurality of preliminary bonding tabs provided at the corresponding perimeter of each of the plurality of print head bonding areas.

12. The method of claim 11, wherein the at least one preliminary bonding tab comprises a pair of preliminary bonding tabs diagonally disposed at opposite corners of each of the plurality of print head bonding areas.

13. The method of claim 10, wherein the at least one preliminary bonding tab is spaced apart from a perimeter of a corresponding one of the plurality of print heads by a predetermined distance.

14. The method of claim 10, wherein the at least one preliminary bonding tab has a height equal to or less than a height of the print head.

15. The method of claim 10, wherein the at least one preliminary bonding tab has a shape of a square wall, a cylindrical wall, or a bent wall.

16. The method of claim 10, wherein the at least one preliminary bonding tab is injection molded in one piece with the ink channel unit.

17. The method of claim 16, wherein the ink channel unit and the at least one preliminary bonding tab are formed of liquid crystal polymer.

18. The method of claim 10, wherein the main adhesive is an epoxy-base adhesive.

19. The method of claim 10, wherein the preliminary adhesive is a UV (ultraviolet) adhesive.

20. The method of claim 10, wherein the main adhesive and the preliminary adhesive are applied using a dispensing process.

21. The method of claim 10, further comprising:
main-bonding the plurality of print heads to the surface of the ink channel unit by heating and hardening the main adhesive.

22. An ink cartridge, comprising:
an ink channel unit having a surface, and having an ink through hole and a bonding area formed on the surface;
a print head disposed on the surface of the ink channel unit; and
one or more bonding tabs formed on the surface of the ink channel unit to align the print head when the print head is attached to the bonding area.

23. The ink cartridge of claim 22, further comprising:
a first bond disposed between the print head and the bonding area; and
a second bond disposed between the print head and the one or more bonding tabs.

24. The ink cartridge of claim 22, wherein:
the print head comprises a first side facing the surface and a second side having an angle with the first side; and
the one or more bonding tabs protrude from the surface of the ink channel unit along the second side of the print head.

25. The ink cartridge of claim 22, wherein the one or more bonding tabs are disposed along a side of the print head.

26. The ink cartridge of claim 22, wherein the one or more bonding tabs have a thickness corresponding to that of the print head.

27. The ink cartridge of claim 22, wherein at least one of the one or more bonding tabs is integral to the ink channel unit in a single monolithic body.

28. The ink cartridge of claim 22, wherein at least one of the one or more bonding tabs is attached to the ink channel unit after the ink channel unit is formed.

29. An ink cartridge, comprising:
an ink channel unit having a first surface with a first ink through hole and a first bonding area, and a second surface with a second ink through hole and a second bonding area;
a first print head disposed on the first surface of the ink channel unit;
a second print head disposed on the second surface of the ink channel unit;
a first bonding tab formed on the first surface to guide the first print head with respect to the second print head and the ink channel unit; and
a second bonding tab formed on the second surface to guide the second print head with respect to the first print head and the ink channel unit.

30. The ink cartridge of claim 29, further comprising a bonding material disposed between the first print head and the first bonding tab and between the second print head and the second bonding tab.

31. An image forming apparatus, comprising:
an ink channel unit having an ink channel, and having a surface with an ink through hole to communicate with the ink channel and a bonding area surrounding the ink through hole;
a print head disposed on the surface of the ink channel unit, and having a nozzle to communicate with the ink through hole of the ink channel unit;
one or more bonding tabs formed on the surface of the ink channel unit to align the print head when the print head is attached to the bonding area; and
a bonding material disposed between a side of the print head and the one or more bonding tabs.

32. The image forming apparatus of claim 31, wherein the one or more bonding tabs are disposed to restrict a movement of the print head in a direction parallel to the surface of the ink channel unit.

33. A method of making an ink cartridge, comprising:
forming an ink channel unit having a surface, and having an ink through hole and a bonding area formed on the surface;
disposing a print head on the surface of the ink channel unit; and
forming one or more bonding tabs formed on the surface of the ink channel unit to align the print head when the print head is attached to the bonding area.
